(19) United States
(12) Patent Application Publication
(10) Pub. No.: US 2002/0184948 A1
(43) Pub. Date: Dec. 12, 2002

(54) Process and device for determining a measurement value in the area of a printing device

(76) Inventors: Holger Leonhardt, Bammental (DE); Wolfgang Eberhardt Luxem, Kiel (DE)

Correspondence Address: Lawrence P. Kessler, Patent Department, NexPress Solutions LLC, 1447 St. Paul Street, Rochester, NY, 14653-7103, US

(21) Appl. No.: 10/162,325

(22) Filed: Jun. 4, 2002

(30) Foreign Application Priority Data
Jun. 8, 2001 (DE) 101 27 909.4

(51) Int. Cl. G01P 15/00

(52) U.S. Cl. 73/514.01

(57) ABSTRACT

Determining a measurement value in particular a distance in the area of a printing device, especially a printing machine, with a measurement instrument arranged on a device component and oriented relative to a measurement or reference area to improve the measurement value determination even when the printing device is operating. An oscillation or vibration of the measurement instrument is recorded and taken into account in the measurement.

### FIELD OF THE INVENTION

The invention involves a process and a device for determining a measurement value, in particular a distance, in the area of a printing device, especially a printing machine, with a measurement instrument arranged on a device component and oriented relative to a measurement or reference area.

### BACKGROUND OF THE INVENTION

It is sometimes necessary to measure selected physical parameters in the area of a printing device, i.e. to determine measurement values of this parameter. This can be done with a measurement instrument, for example, with a sensor or detector, which is arranged on one element of the printing device and is oriented, i.e. aimed, relative to a measurement or reference area.

Measurements of this type must be possible with the required accuracy, frequently also during the operation of the printing device, in particular, when it involves tracking the progress of the work of the printing device using a measurement that is performed continuously or repeatedly by observing a change of the measurement value. For example, the measurement of a distance and/or its change between a measurement instrument and the top sheet of a paper stack, may be made whereby this distance makes it possible to reach a conclusion about the paper stack height still available, i.e. the paper supply still available in the printing machine. In the process, these types of measurements are disturbed in that the measurement instrument is excited by the operation of the printing device into natural oscillations and/or vibrations which, for example, can correlate to the rotation of a printing form cylinder but, however, usually are not harmonic at all. Especially disruptive, for example, is the oscillation component in the direction to the measurement or reference area and/or away from this area, to which a distance is to be measured. The oscillation itself leads to constant irregular distance changes, which can considerably falsify the desired measurement result, so that a measurement with the required precision is systematically not possible.

As a counter-measure, the measurement instrument could be uncoupled so far from the device that oscillation excitation is stopped or damped to a sufficient extent. This, however, not possible at all or only possible to an unsatisfactory extent due to spatial reasons in the area provided for the measurement.

### SUMMARY OF THE INVENTION

Accordingly, the purpose of the invention is to improve the measurement determination, in a printing process and/or a printing device even while the printing device is operating. This purpose is achieved in regard to a process according to the invention in that an oscillation or vibration of the measurement instrument is recorded and taken into account in the measurement. This procedural method according to the invention is of course especially advantageous if, as provided according to a further embodiment of the process according to the invention, a distance is to be measured that changes immediately constantly and fluctuatingly, namely enlarged and reduced, due to the movement components of the oscillations or vibrations lying on the line of the distance measurement, since according to the invention, the error produced as a result can be taken into account and eliminated.

However, also if a value should be measured crosswise to the measurement axis, a distance change has a considerable effect on the measurement result, since depending on the distance according to the radiation principle the angle changes at which the measurement value appears, so that even during such a measurement, the consideration according to the invention is advantageous. In this context, it should be mentioned that taking into account the oscillation or the vibration of the measurement instrument does not absolutely mean that this oscillation itself must be recorded or revealed as the sole value. According to the invention, the oscillation can be recorded by recording the acceleration of the measurement instrument.

A next further embodiment of the invention provides that the result of the oscillation recording is used in order to program a filter that filters out the natural oscillation portion of the measurement instrument equally every time, and makes possible a correspondingly cleaned and/or corrected measurement result. A device according to the invention has an independent solution to the inventive purpose, by a movement-recording instrument for the measurement instrument. The advantage according to the invention of this type of device, as well as the preferred further embodiment, was already depicted in relation to the process according to the invention. In particular, the device according to the invention provides a possible embodiment example in that it contains an actuator with which distance changes and/or oscillations can be brought about, even intentionally and defined, for example, in order to calibrate the device.

The invention, and its objects and advantages, will become more apparent in the detailed description of the preferred embodiment presented below.

### BRIEF DESCRIPTION OF THE DRAWINGS

Embodiment examples, from which additional inventive characteristics result, but to which the invention is not restricted in its scope, are depicted in the drawings. Shown are:

FIG. 1 which is a schematic block diagram of a first embodiment example of a device according to the invention;

FIG. 2 which is a second embodiment example in the schematic block diagram of a device according to the invention;

FIG. 3 which is a third embodiment example as a schematic block diagram of a device according to the invention;

FIG. 4 which is a typical example of an oscillation range of a mount of a measurement sensor in the area of a stack centering mechanism of a printer; and

FIG. 5 which is an example, using a block diagram, of a signal processing of measurement signals taking into account an oscillation range as in FIG. 4.

### DETAILED DESCRIPTION OF THE INVENTION

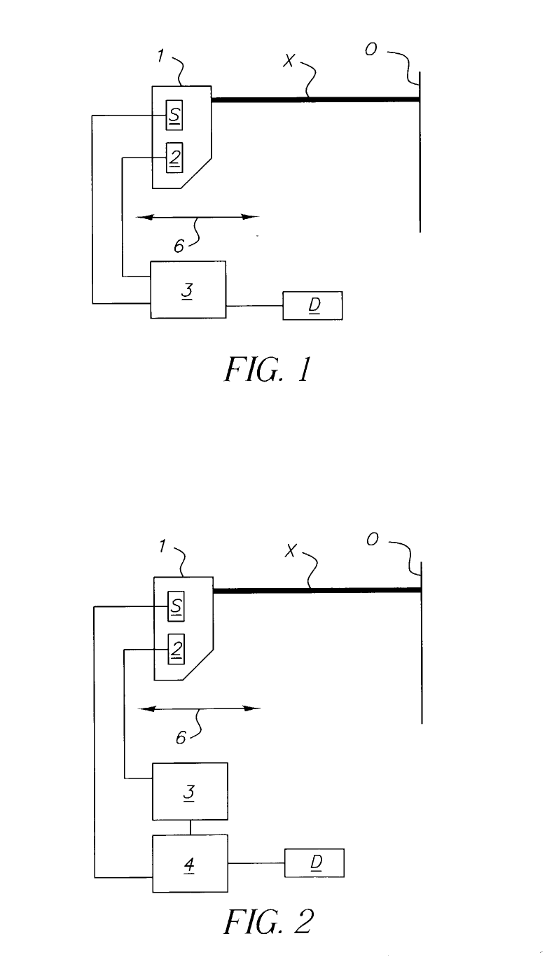

FIG. 1 shows a first embodiment example of a device according to the invention in a schematic block diagram. For the distance measurement between machine parts on systems with natural vibrations (e.g. printers), the oscillations often cannot be kept away from the distance measurement device or may only be isolated at a large expense. These oscillations falsify the distance measurement result. The device according to the invention provides for recording these undesired oscillations of the distance measurement system and correcting the distance measurement result accordingly.

In the form depicted in FIG. 1, the device according to the invention contains a distance measurement unit 1, known in principle, with a distance measurement sensor S for determining the distance X of the distance measurement unit 1 from an object O, which indicates the measurement or reference area value, preferably in the area of a printing machine. According to the invention, the distance measurement unit 1 also contains an acceleration recorder 2 for recording the acceleration of the distance measurement unit 1 and/or the sensor S at a natural oscillation of the distance measurement unit 1 in the oscillation direction, which is indicated by a double arrow 6. The distance measurement unit 1 is associated with a data processing unit 3, which for its part has an indicator or a display D.

The process of distance measurement with the device according to the invention assumes, as already explained, that it is not possible to mount and hold the distance measurement unit 1 in a manner completely free of oscillations relative to the object O to be observed. In this way, in systems that have natural oscillations, such as, for example, continuous printers, a superposition of measurement value and oscillation amplitude occurs. In particular, for high-precision distance measurement processes, these oscillation amplitudes contribute to a noticeable falsification of the measurement signal and/or result. According to the invention, it is proposed to record the natural oscillation of the distance measurement unit 1 using the acceleration recorder 2. With the resulting measurement value to be obtained from that, the following necessary information for the process can be calculated using the data processing unit 3:

First, the amplitude s₁ of the oscillation at any point in time can be calculated as a value of the distance-time function

s₁(t)=∫∫a(t)dtdt

and secondly, the phase and amplitude spectrum of the oscillation can be determined by Fourier analysis of the calculated distance-time function s₁ (t). In the process, it is then to be assumed that the initial signal S₃ (t) of the distance measurement unit 1 is a superposition from two signal portions, namely the oscillation amplitude s₁ (t) and the distance X of interest, which should be determined as a possibly time-dependent value S₂ (t). Since S₁ (t) is known through the measurement data of the acceleration recorder 2 and S₃ (t) is known through the measurement data of the sensor S, the data processing unit 3 can compute back to the exact distance S₂ (t).

It is advantageous in the process according to the invention that the stability of the sensor suspension does not enter into the measurement accuracy of the distance measurement unit. As a result, the suspension would no longer need to compensate for oscillation. Moreover, higher measurement accuracy can be achieved with existing suspensions. It is further advantageous that asynchronous changes of the oscillation behavior of the device are also compensated. Furthermore, with the process according to the invention, distance and length changes can be recorded, whose change occurs with a frequency which lies in the order of magnitude of the natural oscillation frequency of the measurement device.

In the embodiment example of the device according to the invention, which is depicted in FIG. 2, the result of the oscillation analysis obtained through the acceleration recorder 2 is used to parameterize a programmable filter 4. The parameterization is done such that the filter 4 filters out, in a manner with proper amplitude and phase, the natural oscillation portion s₁ (t) of the distance measurement unit 1 at its outlet. A band filter, such as the filter 4, can be used that is programmable in its throughput characteristics, whereby high and low passes are understood as special forms of a band filter. Advantageous in this embodiment example is the simplification of manufacturing. However, a disadvantage is that distance changes with frequencies near the natural oscillation frequency cannot be detected. Furthermore, it is a disadvantage that changes of the oscillation behavior are reacted to slower than for a device according to FIG. 1.

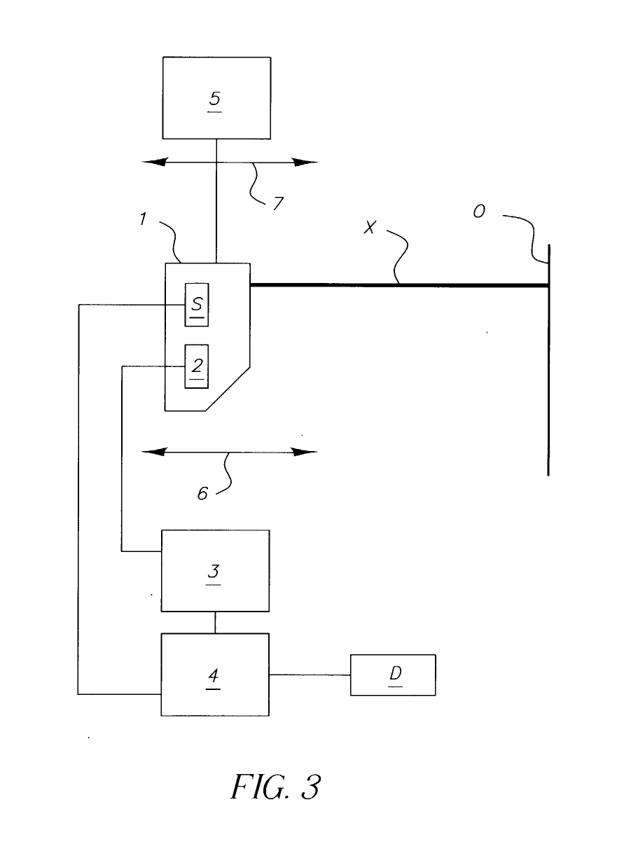

In the third embodiment example according to FIG. 3, another actuator 5 is added to the device according to the invention. With this actuator, the distance measurement unit 1 can be actively moved in the movement direction indicated by the double arrow 7, for example, for purposes of calibration.

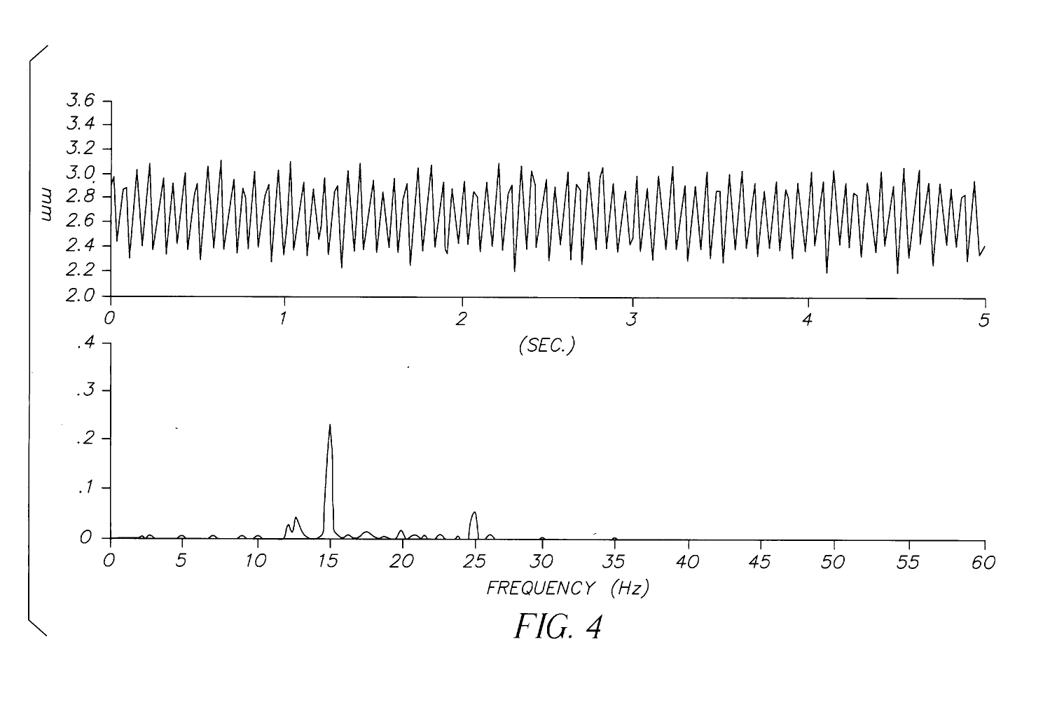

FIG. 4 shows a typical, measured oscillation range of a mount of a sensor on a stack centering device for centering a paper stack transversally to a printer operated without paper run at 18000 revolutions per hour. Two function curves are shown for this purpose in FIG. 4, one below the other, namely the oscillation path (amplitude s₁) in millimeters as a function of time (t) in seconds (top), and the portion amount of the respective frequencies in the oscillations, contained in the above function curve, normalized to a total portion of 1, in Hertz (bottom). In the bottom curve, pronounced natural oscillations of the natural oscillations of the sensor can be recognized, especially at 15 Hz and at additional intervals of 5 Hz from that, i.e. the multiples of the rotational speed of the printer given above.

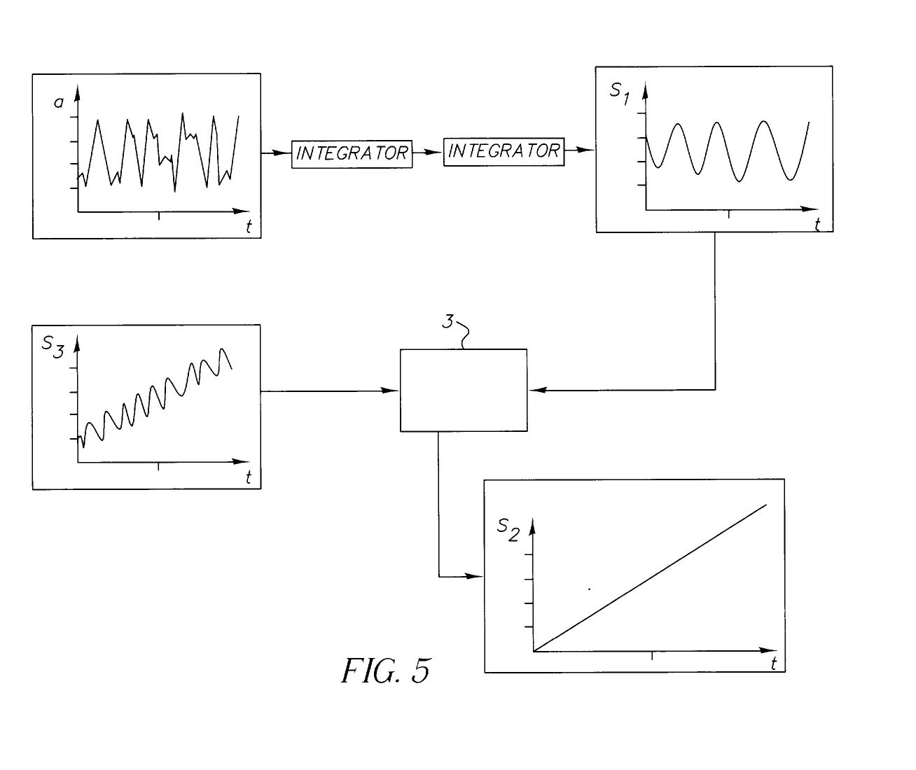

FIG. 5, using a block diagram, shows an example of a signal processing of a device according to the invention based on an oscillation range according to FIG. 4. From an acceleration range of the acceleration a, which was obtained with the acceleration recorder 2, a path-time curve is obtained using two integrators, i.e. an oscillation amplitude curve s₁ (t) of the natural oscillation of the sensor S as a function of time. This information is entered into a data processing unit 3, and the distance measurement curve S₃ (t) recorded by the sensor S gets in on a second branch of this unit 3. In the data processing unit 3, from the information from both branches, the measurement distance curve S₂ (t), which is true and/or cleaned by the natural oscillation portion of the sensor S, is determined as a function of time. In the example shown, the measured distance increases proportionally to time.

The invention has been described in detail with particular reference to certain preferred embodiments thereof, but it will be understood that variations and modifications can be effected within the spirit and scope of the invention.

What is claimed is:

1. Process for determining a measurement value, in particular a distance, in the area of a printing device, especially a printer, with a measurement instrument arranged on a device component and oriented relative to a measurement or reference area, characterized in that an oscillation or vibration of the measurement instrument is recorded and taken into account in the measurement.

2. Process according to claim 1, characterized in that the acceleration of the measurement instrument is recorded.

3. Process according to claim 2, characterized in that from the recorded acceleration, the amplitude path is determined relative to the measurement or reference area, and considered as a distance change for a distance measurement between the measurement instrument and the measurement or reference area.

4. Process according to claim 1, characterized in that the result of the oscillation recording is used in order to parameterize a programmable filter so that the filter filters out, in a manner with proper amplitude and phase, the natural oscillation portion of the measurement instrument during the recording of the measurement value.

5. Device for determining a measurement value, in particular a distance, in the area of a printing device, especially a printer, with a measurement instrument arranged on a device component and oriented relative to a measurement or reference area characterized by a movement recording instrument for said measurement instrument (5).

6. Device according to claim 5, characterized in that said movement-recording instrument is an acceleration recorder (2).

7. Device according to claim 5, characterized by a processing unit (3) that is connected to said measurement instrument (S) and said movement-recording instrument (2).

8. Device according to claim 6, characterized by a programmable signal filter (4) connected to said acceleration recorder (2).

9. Device according to claim 5, characterized by an actuator (5) for movement and/or position change of said measurement instrument (S).
